(19) United States
(12) Patent Application Publication
(10) Pub. No.: US 2014/0227169 A1
(43) Pub. Date: Aug. 14, 2014

(54) METHOD FOR MANUFACTURING ZINC OXIDE THIN FILM, AND DEVICE

(71) Applicant: NIKON CORPORATION, Tokyo (JP)

(72) Inventors: Yasutaka Nishi, Tokyo (JP); Makoto Nakazumi, Yamato (JP); Yusuke Taki, Sagamihara (JP)

(73) Assignee: NIKON CORPORATION, Tokyo (JP)

(21) Appl. No.: 14/190,427

(22) Filed: Feb. 26, 2014

Related U.S. Application Data
(63) Continuation of application No. PCT/JP2012/071732, filed on Aug. 28, 2012.

(30) Foreign Application Priority Data
Aug. 31, 2011 (JP) 2011-188304

(51) Int. Cl. C01G 9/02; B05D 3/02

(52) U.S. Cl. CPC C01G 9/02; B05D 3/0254; B05D 3/0218
USPC 423/622; 427/372.2; 427/314

(57) ABSTRACT

A method of manufacturing a zinc oxide thin film includes: preparing a basic solution containing tetrahydroxozincate (II) ions and having a pH of 10 or more; diluting the basic solution such that the pH becomes 8.5 or less; applying the basic solution to a substrate; and heating the basic solution.

### CROSS-REFERENCE TO RELATED APPLICATION

This is a Continuation Application of International Application No. PCT/JP2012/71732, filed on Aug. 28, 2012, which claims priority on Japanese Patent Application No. 2011-188304, filed on Aug. 31, 2011. The contents of the aforementioned applications are incorporated herein by reference.

### BACKGROUND

1. Field of the Invention

The present invention relates to a method of manufacturing a zinc oxide thin film, and a device.

2. Background

A zinc oxide thin film is a material having both visible light transparency and electrical conductivity, and therefore has been used as a transparent electrode of a flat panel display (FPD), a thin film solar cell, or the like. Generally, a method by which these zinc oxide thin films are fabricated according to a vacuum deposition technique using a sputtering method or the like is commonly used; however, such related art requires a large-scale exhaust system as the manufacturing equipment. Therefore, the obtained zinc oxide thin films are likely to become costly.

In addition, a method in which a zinc oxide thin film is synthesized by a wet method without using a vacuum deposition technique is also known. This method typically includes baking at 300° C. or more in most cases, and is limited to a case where the material of a substrate on which the thin film is formed is a material having high heat durability, such as glass.

Thus, a method by which zinc oxide fine particles can be obtained using a wet method and low temperatures (for example, heating at 30° C. or more and 180° C. or less) has been proposed (for example, refer to Japanese Patent Publication No. 4304343). In the method of Japanese Patent Publication No. 4304343, a sol in which zinc hydroxide is dispersed is heated to between 30° C. and 180° C., and thereby a sol in which zinc oxide fine particles are dispersed can be easily obtained. By applying the obtained sol to a substrate, a zinc oxide thin film can be easily obtained.

### SUMMARY

However, in the case that a basic solution is mixed with a solution containing a zinc salt as in the above-described method, even after the solution is heated and is formed into a sol in which zinc oxide fine particles are dispersed, ions which originate from the basic solution remain in the sol. In the case that this sol is applied and a thin film is fabricated, impurities which originate from these ions other than zinc also form a film and are produced. As a result, contaminants become mixed in the obtained thin film, and there is a concern that the quality of the thin film is deteriorated.

An object of an aspect of the present invention provides a manufacturing method which is a non-vacuum and low-temperature film formation process in order to manufacture high-quality zinc oxide.

A method of manufacturing a zinc oxide thin film according to an aspect of the present invention includes: preparing a basic solution containing tetrahydroxozincate (II) ions and having a pH of 10 or more; diluting the basic solution such that the pH becomes 8.5 or less; applying the basic solution to a substrate; and heating the basic solution.

In addition, a device according to an aspect of the present invention includes a zinc oxide thin film manufactured by using the above method.

According to an aspect of the present invention, it is possible to provide a manufacturing method which is a non-vacuum and low-temperature film formation process in order to manufacture high-quality zinc oxide.

### BRIEF DESCRIPTION OF THE DRAWINGS

FIG. 1 is a diagram showing a method of manufacturing a zinc oxide thin film according to the present embodiment.

FIG. 2 is a diagram showing the method of manufacturing a zinc oxide thin film according to the present embodiment.

FIG. 3 is a graph showing a ratio of the number of atoms of sodium atoms to zinc atoms contained in a thin film.

FIG. 4 is a SEM image showing a state of a thin film formed by differentiating the PH of a coating solution.

FIG. 5 is a schematic diagram showing an example of a manufacturing apparatus used for manufacturing zinc oxide.

FIG. 6A shows a result of Example 1.

FIG. 6B shows a result of Example 1.

FIG. 7 shows a result of Example 1.

FIG. 8A shows a result of Comparative Example 1.

FIG. 8B shows a result of Comparative Example 1.

FIG. 9A shows a result of Example 2.

FIG. 9B shows a result of Example 2.

FIG. 10 shows a result of Example 2.

FIG. 11A shows a result of Comparative Example 2.

FIG. 11B shows a result of Comparative Example 2.

FIG. 12A shows a result of Comparative Example 3.

FIG. 12B shows a result of Comparative Example 3.

FIG. 13 shows a result of Example and Comparative Example.

FIG. 14A shows a result of Example 4.

FIG. 14B shows a result of Example 4.

FIG. 15 shows a result of Example 4.

### DESCRIPTION OF THE EMBODIMENTS

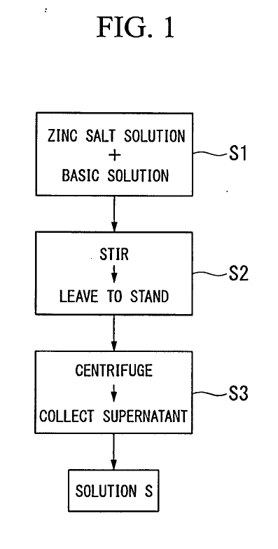

Hereinafter, with reference to FIG. 1 to FIG. 5, a method of manufacturing a zinc oxide thin film according to the present embodiment will be described. Note that, in the following drawings, the dimensions and ratios of each constituent element are varied for ease of understanding.

A method of manufacturing a zinc oxide thin film of the present embodiment includes preparing a basic solution which contains tetrahydroxozincate (II) ions onto a substrate, diluting the basic solution such that the pH becomes 8.5 or less, applying the basic solution on the substrate, and heating the basic solution.

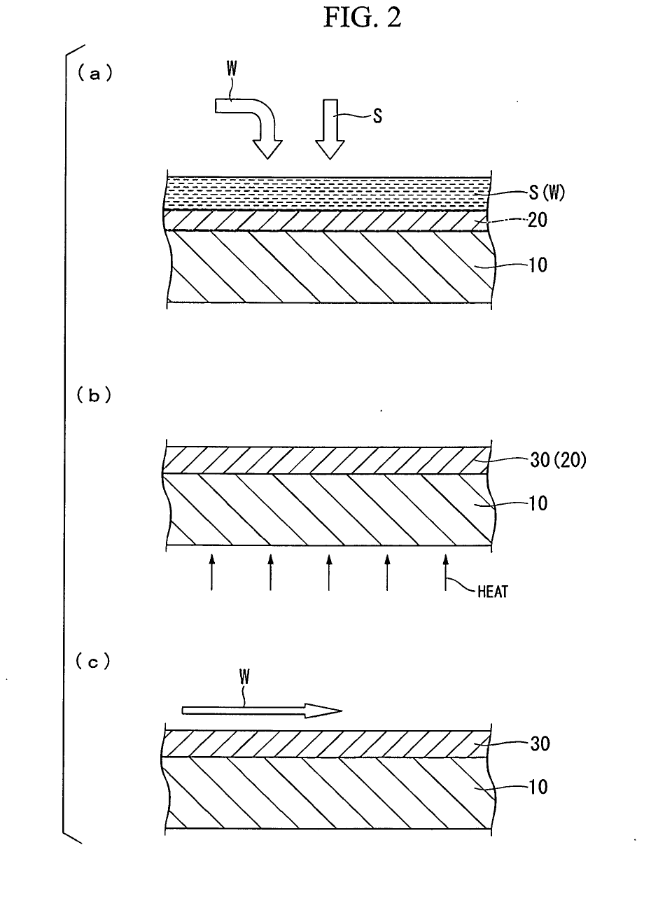

FIGS. 1 and 2 show a method of manufacturing a zinc oxide thin film according to the present embodiment, FIG. 1 is a flowchart showing a method of preparing a coating solution, and FIG. 2 is a process diagram showing an example of a manufacturing method of a zinc oxide thin film.

First, as shown in FIG. 1, a solution is prepared in which a zinc salt is dissolved (a zinc salt solution) and mixed with a basic solution (step S1), and then stirred at room temperature and left to stand for about 30 minutes (step S2). Water is preferably used as the solvent, and it is preferable to mix an aqueous solution of a zinc salt and a basic aqueous solution. In the present embodiment, water is used as the solvent.

As the zinc salt, it is possible to use a water-soluble salt, and examples can be zinc nitrate, zinc chloride, zinc acetate, zinc citrate, zinc sulfate, and the like.

In addition, examples of a solute are sodium hydroxide, potassium hydroxide, calcium hydroxide, ammonia, and the like.

According to the above, zinc ions (Zn²⁺) dissolved in the solution bind to hydroxide ions (OH⁻) and become zinc hydroxide (Zn(OH)₂), and a colloidal white deposit is generated. Moreover, by setting the pH of the solution to 10 or more, zinc hydroxide as a white deposit binds to hydroxide ions, generates tetrahydroxozincate (II) ions ([Zn(OH)₄]²⁻), and is dissolved into the solution.

Next, the white deposit of zinc hydroxide remaining in the solution is separated using a centrifuge, and the supernatant is collected (step S3). The solution thus obtained is a “basic solution containing tetrahydroxozincate (II) ions” and can be used as a coating solution to be applied to a substrate. In the following description, the term “basic solution containing tetrahydroxozincate (II) ions” may be referred to as a “solution S” or a “coating solution”.

Next, as shown in FIG. 2, a substrate on which a zinc oxide thin film is formed is prepared, and the target zinc oxide thin film is formed using a solution S.

As shown in FIG. 2 (a), the solution S is applied to a substrate 10. As the formation material of the substrate 10, it is possible to use a variety of materials such as glass or a resin material. As the method of applying the solution S, it is possible to employ a variety of generally known methods, and examples can be a dropping method using a dispenser, an ink-jet method (droplet discharge method), a spin coating method, a dip coating method, a roll coating method, a slit coating method, or the like.

In addition, simultaneously with the application of the solution S, or before the solution S is applied, pure water W is added to the solution S, and the solution S is diluted. By the dilution, the PH of the solution S is reduced, the reaction in which zinc hydroxide is generated from tetrahydroxozincate (II) ions is promoted, and zinc hydroxide is deposited onto the surface of the substrate 10 and a thin film 20 is easily generated.

This dilution is performed while controlling the pH of the solution S to be 8.5 or less. Thereby, contaminants which originate from ions of the basic solution used in step S1 of FIG. 1 are not likely to be deposited in the obtained thin film. As the contaminants, in the case that a metal hydroxide is used as the solute of the basic solution, a metal compound which originates from cations (metal ions) can be considered. In addition, in the case that ammonia is used as the solute of the basic solution, ammonia desorbed from tetraammine zinc (II) ions ([Zn(NH₃)₄]²⁺) which is produced by the reaction between ammonia and zinc ions can be considered. The presence of contaminants can be ascertained by analyzing the thin film produced on the substrate surface.

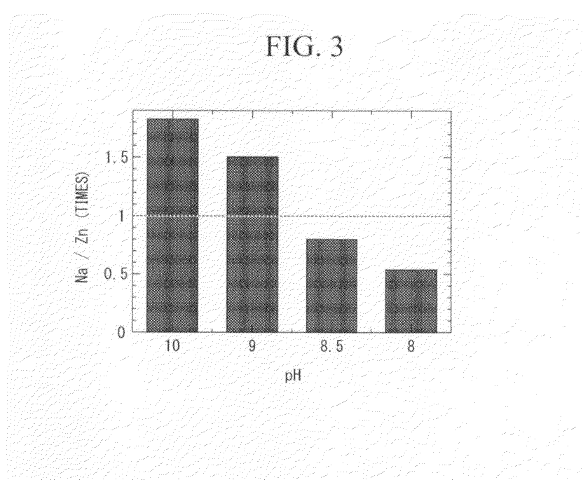

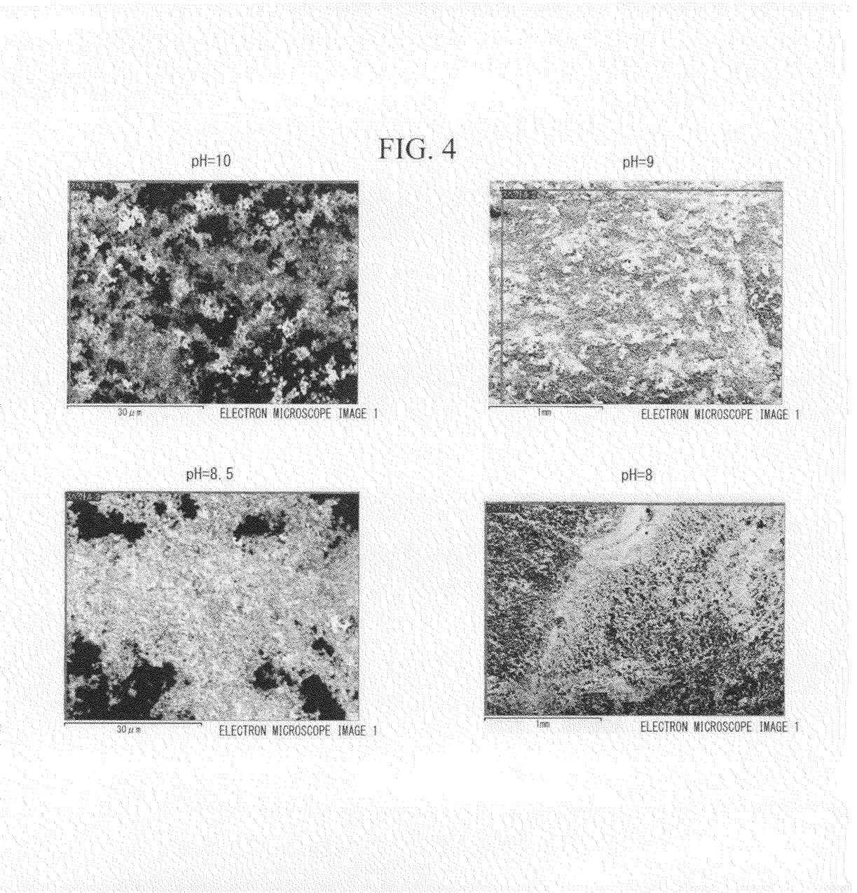

FIGS. 3 and 4 are diagrams showing a relation between the change in the pH of the solution S and a state of the thin film produced on the substrate surface, FIG. 3 shows the amount of contaminants, and FIG. 4 is a SEM image of the thin film.

Here, after a sodium hydroxide aqueous solution is added to a zinc nitrate aqueous solution of 0.1 mol/L such that the pH is adjusted to be 10 or more and the solution is sufficiently stirred, the solution is left to stand for about 30 minutes, and then separated by a centrifuge at 10000 rpm for about 10 minutes, thereby the supernatant is collected. The collected supernatant is used as the solution S. By diluting the collected solution S with pure water, a coating solution in the range of pH 8-10 is prepared, and is directly dropped onto a glass substrate. Thus obtained model samples are evaluated.

FIG. 3 is a graph, with respect to the thin film formed on the glass substrate by the above-described method, showing a ratio of the number of atoms of sodium atoms to zinc atoms contained in the thin film. As the number of atoms of each element, the value obtained by Energy Dispersive X-ray spectrometry (EDX) as the concentration of the number of atoms in the thin film is employed.

As shown in FIG. 3, in the above model samples, in order that a compound containing zinc and a compound containing sodium may be deposited at equal amount (1:1), it was found that it is necessary to reduce the pH to a pH of 8.5-9, and a pH of about 8.7. In addition, in the case that the pH is 8.5 or less, a compound containing zinc is preferentially deposited, and therefore it is preferable to dilute the solution with pure water to an amount in which the pH becomes 8.5 or less.

FIG. 4 is a SEM image showing a state of a thin film prepared using coating solutions of which the pH is different. As shown in the drawing, along with the decrease of the pH, grains which constitute the thin film tend to be deposited in a state where the aggregation between grains is relaxed. It is preferable to dilute the coating solution such that the pH becomes 8.5 or less because the obtained thin film becomes dense.

With reference to FIG. 2, the thin film 20 is heated as shown in FIG. 2 (b). The drawing shows that the thin film 20 is heated by heating the substrate 10. Obviously, the thin film 20 and the substrate 10 may be heated as a whole by increasing the temperature of the space in which the substrate 10 is placed. Moreover, the solution S which is shown in FIG. 2 (a) is excluded in the drawing; however, the solution S may be present on the substrate 10 at the time of heating.

By the heating, water desorbs from zinc hydroxide which constitutes the thin film 20, and zinc oxide (ZnO) is generated. It is preferable that the heating temperature become 60° C. or more, and the heating temperature be more preferably 80° C. or more. In addition, it is preferable that the heating temperature be 150° C. or less. For example, the heating temperature can be about 50, 60, 70, 80, 90, 100, 110, 120, 130, 140, 150, or 160°. By this heating, a thin film 30 of zinc oxide is generated on the surface of the substrate 10.

Next, as shown in FIG. 2 (c), the thin film 30 on the surface of the substrate 10 is rinsed using pure water W. In general, because the solubility of zinc hydroxide which constitutes the thin film 20 or zinc oxide which constitutes the thin film 30 in water is lower than that of contaminants which are deposited in these films, it is possible to easily remove the contaminants by rinsing.

It is preferable to use warm water having a higher temperature than the ambient temperature as pure water W which is used for the above-described rinsing because the dissolution and rinsing of the contaminants are promoted. For example, warm water of about 70° C. may be used for the rinsing.

As a method of rinsing, various methods such as spraying of pure water W to the thin film 30 or immersion of the substrate 10 on which the thin film 30 is formed in pure water W can be employed.

Note that, in FIG. 2, the application of the solution S shown in FIG. 2 (a) and the heating shown in FIG. 2 (b) are separately described; however, the substrate 10 may be heated in advance, and then the solution S may be applied to the heated substrate 10.

In addition, in FIG. 2, an example in which the heating is performed after the solution S is applied on the substrate 10 is described; however, the solution S may be heated in advance, and then the heated solution S may be applied on the substrate 10.

In this way, a zinc oxide thin film of high purity can be manufactured.

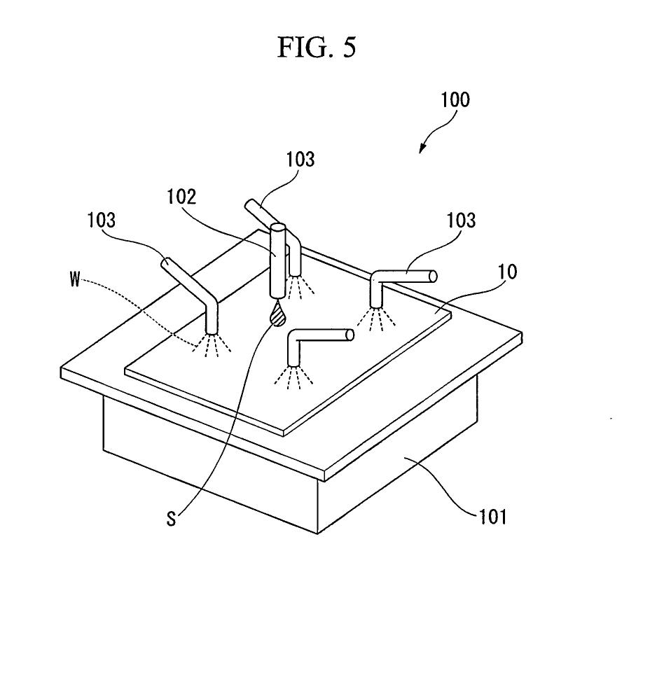

FIG. 5 is a schematic diagram showing an example of a manufacturing apparatus used for the manufacturing method of zinc oxide of the present embodiment. As shown in the drawing, a manufacturing apparatus 100 includes a stage 101 on which the substrate 10 is placed, a nozzle 102 for applying the solution S on the substrate, a spray nozzle 103 for spraying pure water. The stage 101 includes a heater which is not shown in the drawing, and is configured to be capable of heating the substrate 10 on the stage 101.

In the case that a zinc oxide thin film is manufactured using the manufacturing apparatus 100 described above, after the substrate 10 is placed on the stage 101, this substrate 10 is heated at 150° C. or less, and the solution S is dropped. On the surface of the substrate 10, the dropped solution S is heated, zinc hydroxide is deposited, and the production of zinc oxide proceeds.

In addition, when the solution S is dropped, is applied, and is half-dry, pure water W is sprayed from the spray nozzle 103 while dropping the solution S. By pure water W which is sprayed from the spray nozzle 103, the dropped solution S is locally diluted, and the deposition of zinc hydroxide is promoted. In addition, rinsing of the thin film produced on the surface of the substrate 10 is also performed at the same time.

Finally, after the surface of the substrate 10 is dried, the thin film formed on the surface is lightly rinsed using warm water (pure water) of about 70° C., and thereby a zinc oxide thin film is obtained.

Note that, FIG. 5 shows that the substrate 10 is placed on the stage 101; however, it is also possible to form a film while transporting the substrate 10.

According to the method of manufacturing a zinc oxide thin film described above, it is possible to manufacture a zinc oxide thin film of high purity and high quality by a non-vacuum and low-temperature film formation process.

### EXAMPLES

Hereinafter, Examples of the present invention will be described; however, the present invention is not limited to these Examples.

A physical property measurement method in Examples and Comparative Examples are as follows.

### (Film Composition)

The film composition was obtained by using Energy Dispersive X-ray spectrometry (EDX).

### (Surface Shape)

The surface shape of the obtained zinc oxide thin film was observed by using Scanning Electron Microscope (SEM).

### (Crystal Structure Analysis)

The crystal structure was measured by performing the θ-2θ scan of X-ray diffraction method.

### (Surface Composition)

The surface composition was calculated from the integral intensity ratio of the spectrum of the contained element by X-ray photoelectron spectroscopy.

### Example 1

100 mL of a 0.1-mol/L sodium hydroxide aqueous solution was added to 10 ml of a 0.1-mol/L zinc nitrate aqueous solution, and a coating solution of pH 12 was prepared. After the solution was sufficiently stirred, the solution was left to stand for about 30 minutes. Then, a colloidal white deposit was separated using a centrifuge at an operating condition of 10000 rpm and 10 minutes, and the supernatant was collected as the coating solution.

The coating solution was dropped onto a glass substrate heated at 100° C., and at the same time, pure water (about 70° C.) was sprayed onto the substrate such that the pH of the coating solution becomes 8, whereby dilution of the coating solution on the substrate and rinsing of impurities were performed.

Next, after the substrate surface was dried, the substrate surface was lightly rinsed with warm water of about 70° C. again, and then the substrate was completely dried. Thus, the target thin film was obtained.

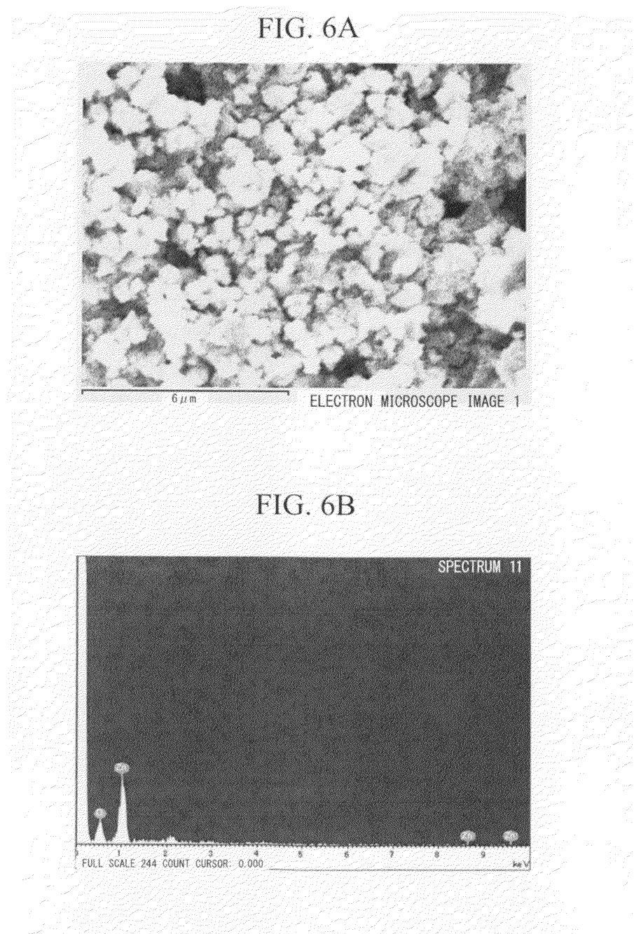

FIG. 6A is a SEM image of the fabricated thin film, and FIG. 6B is an EDX spectrum of the thin film.

As shown in FIG. 6A, it was found that grains of 1 μm or less are grown on the substrate. In addition, as shown in FIG. 6B, it was found that a zinc atom and an oxygen atom are main constituents as the constitution of the thin film.

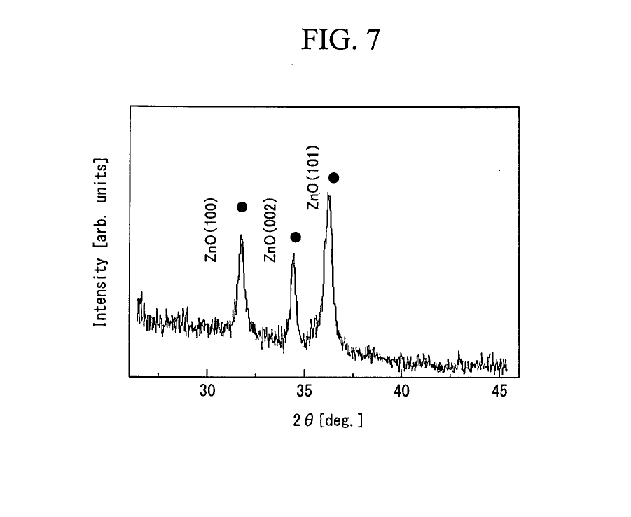

FIG. 7 shows an X-ray diffraction result of the thin film measured by the θ-2θ method using an X-ray diffraction apparatus. As a result of the measurement, a (100) plane, a (002) plane, and a (101) plane of zinc oxide are confirmed, and it was found that the grains which constitute the thin film are zinc oxide crystals.

### Comparative Example 1

Film formation was performed in a similar way as Example 1 other than not performing spraying of pure water at the time of dropping of the coating solution onto the substrate and not performing rinsing with warm water after film formation.

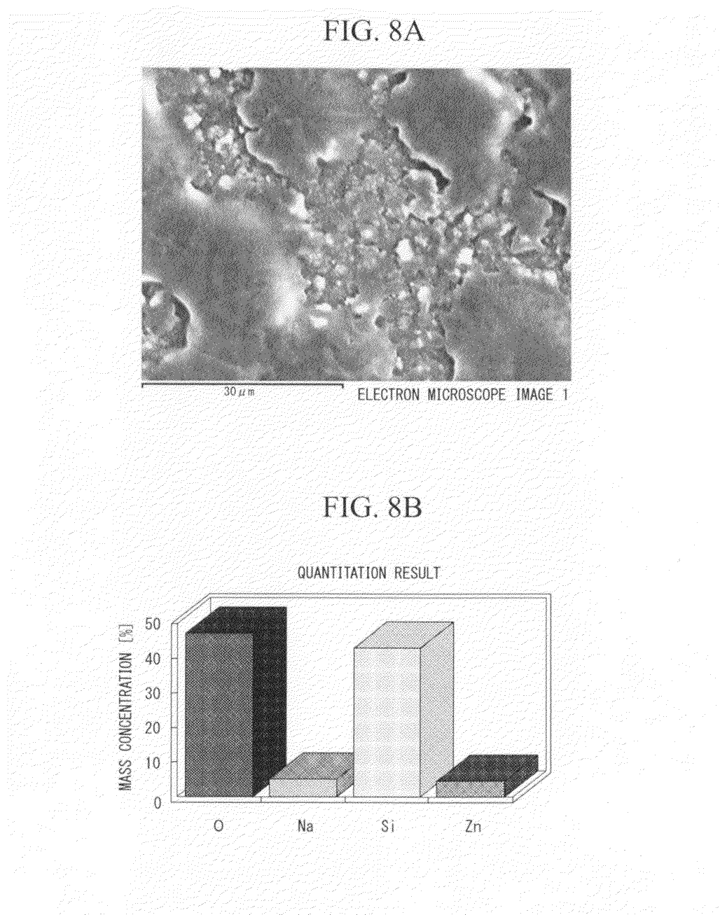

FIG. 8A is a SEM image of the fabricated thin film, and FIG. 8B is a result of the composition analysis of the thin film by EDX.

As shown in FIG. 8B, Na atoms which originate from the sodium hydroxide aqueous solution which is the basic solution are mixed to the same extent with zinc atoms contained in zinc oxide which is the target product. Note that, part of silicon atoms and oxygen atoms detected in FIG. 8B is a value measured for the glass which is the substrate.

In addition, as shown in FIG. 8A, because crystalline grains of zinc oxide are covered by a Na compound of several 10 μm, it was found that crystals containing many contaminants other than zinc oxide which is the target object are grown.

### Example 2

After preparing a coating solution by a similar method as Example 1, the coating solution was diluted using pure water until the pH becomes 8.5.

Next, the coating solution was heated to about 80° C., a substrate was immersed in the coating solution, and application of the coating solution onto the substrate was performed. Then, by taking out the substrate from the coating solution and drying the substrate, film formation was performed. Total ten sets of an application (immersion) step and a drying step were repeated, and film formation onto the substrate was performed.

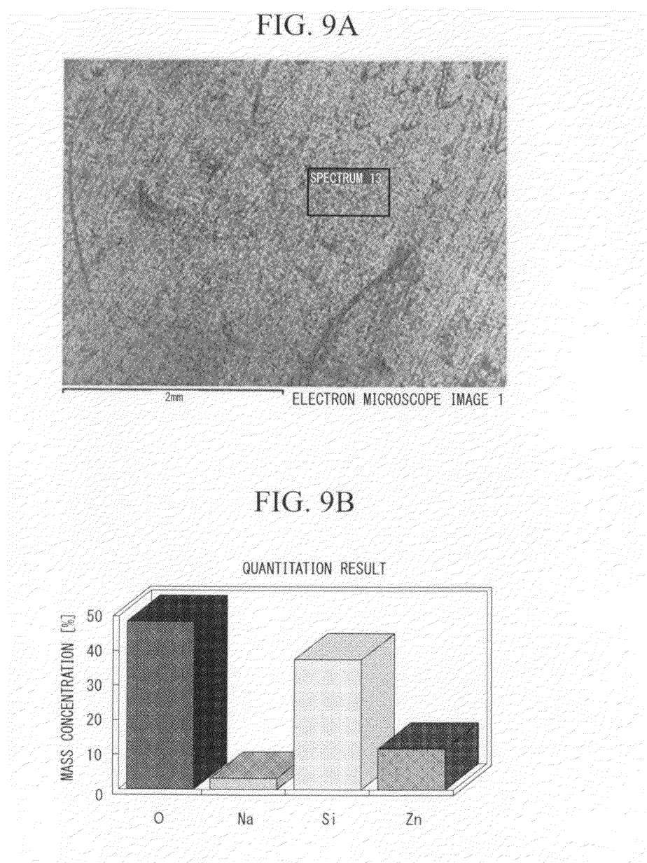

FIG. 9A is a SEM image of the fabricated thin film, and FIG. 9B is a result of the composition analysis by EDX.

As shown in FIG. 9A, grains of 1 μm or less are grown and form the thin film. In addition, as shown in FIG. 9B, the thin film includes more zinc atoms contained in zinc oxide which is the target product than Na atoms which originate from the sodium hydroxide aqueous solution which is the basic solution. Note that, part of silicon atoms and oxygen atoms detected in FIG. 9B is a value measured for the glass which is the substrate.

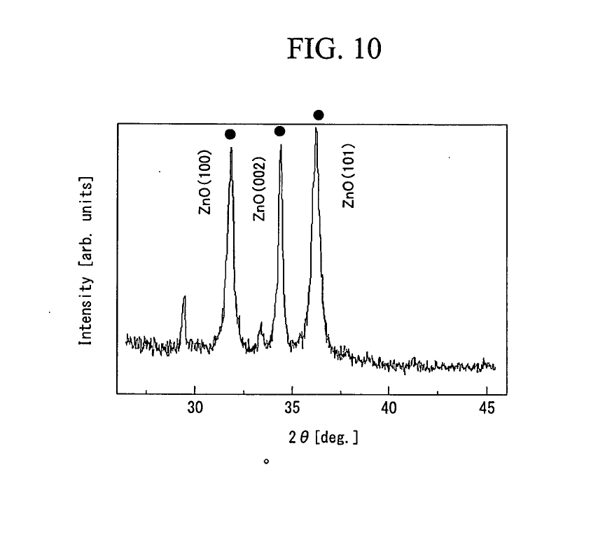

FIG. 10 shows an X-ray diffraction result of the thin film measured by the θ-2θ method using an X-ray diffraction apparatus. As a result of the measurement, a (100) plane, a (002) plane, and a (101) plane of zinc oxide are confirmed, and it was found that the grains which constitute the thin film are zinc oxide crystals.

### Comparative Example 2

After preparing a coating solution by a similar method as Example 1, film formation was performed in a similar way as Example 2 other than not performing dilution by pure water. The pH of the coating solution which was not diluted was 12.

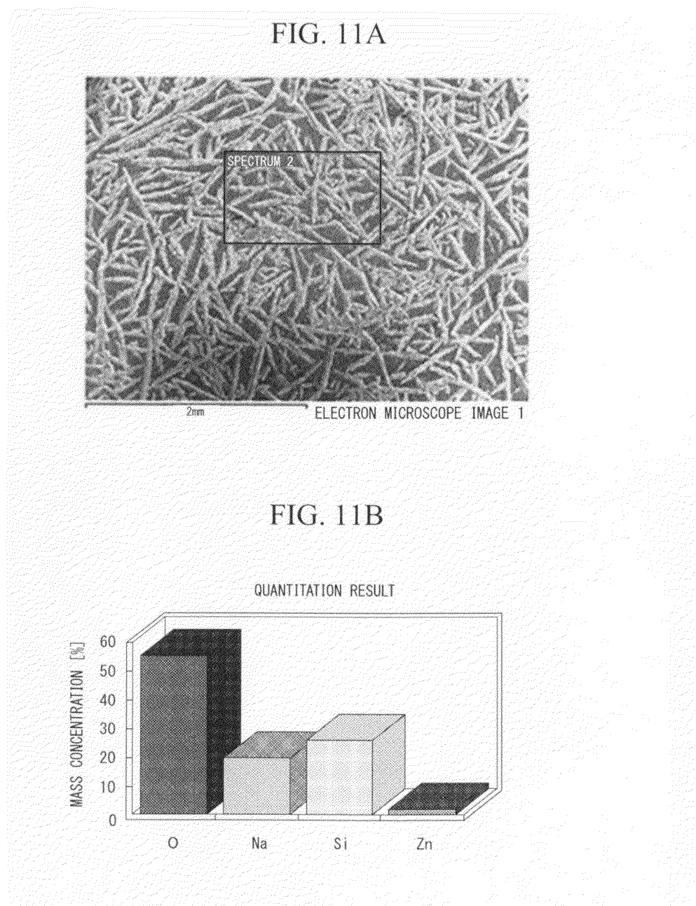

FIG. 11A is a SEM image of the fabricated thin film, and FIG. 11B is a result of the composition analysis by EDX.

As shown in FIG. 11A, unlike Example 2, it was found that the thin film is constituted of needle-like crystals, and it is estimated that crystals having a different composition from that of Example 2 are grown. As shown in FIG. 11B, the thin film includes more Na atoms which originate from the sodium hydroxide aqueous solution which is the basic solution than zinc atoms contained in zinc oxide which is the target product, and it was found that Na compounds rather than zinc crystals are grown.

### Comparative Example 3

After preparing a coating solution by a similar method as Example 1, film formation was performed in a similar way as Example 2 other than diluting the coating solution using pure water until the pH becomes 10.

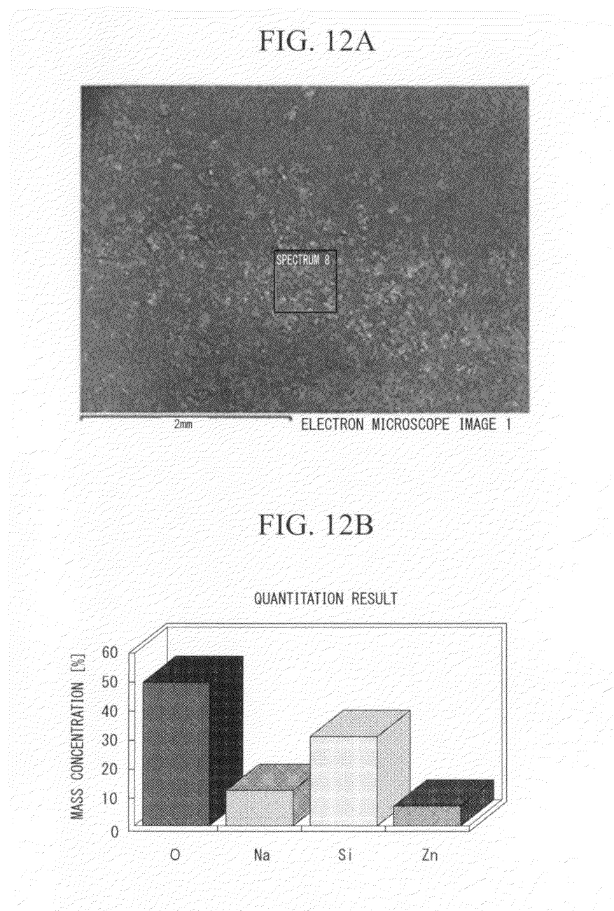

FIG. 12A is a SEM image of the fabricated thin film, and FIG. 12B is a result of the composition analysis by EDX.

As shown in FIG. 12A, unlike Comparative Example 2, it was found that the growth of needle-like crystals in the thin film is suppressed. However, as shown in FIG. 12B, it was found that, although the number of Na atoms is reduced compared to that of Comparative Example 2, the thin film includes more Na atoms which originate from the sodium hydroxide aqueous solution which is the basic solution than zinc atoms contained in zinc oxide which is the target product, and includes more Na compounds than zinc crystals.

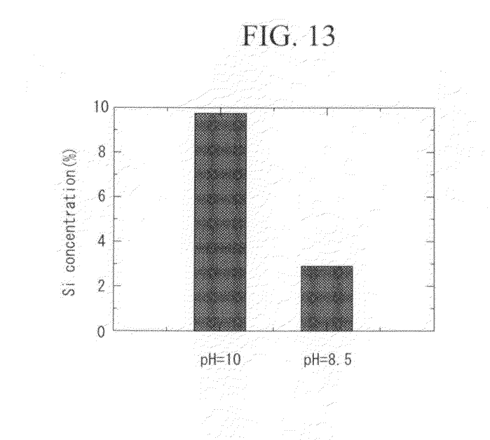

FIG. 13 is a graph showing the degree of surface coverage by the thin film with respect to the samples in which the thin film is formed in Example 2 (the pH of the coating solution: 8.5) and Comparative Example 3 (the pH of the coating solution: 10). The figure shows the ratio of silicon atoms close to the surface, which is calculated from the spectrum obtained by performing a measurement of the thin film by XPS. Because the thickness of the crystals constituting the thin film formed on the substrate surface is greater than the photoelectron emission depth of XPS, it can be said that the coverage of zinc oxide is higher as the ratio of detected silicon atoms is smaller.

As shown in the figure, in the case that the dilution degree is changed from pH 10 (Comparative Example 3) to pH 8.5 (Example 2), the ratio of silicon atoms in the measurement result is relatively reduced. Therefore, it is suggested that, as the pH is lower, the aggregation between grains constituting the thin film is relaxed, and the degree of surface coverage of the thin film is increased.

### Example 3

After preparing a coating solution in a similar way as Example 1, by dropping the coating solution onto a glass substrate heated at 100° C. and drying the substrate, a thin film was formed.

Next, after drying the substrate surface, the substrate was immersed in warm water of about 70° C., and the substrate rinsing was performed. Then, by taking out the substrate from warm water and completely drying the substrate, the target thin film was obtained.

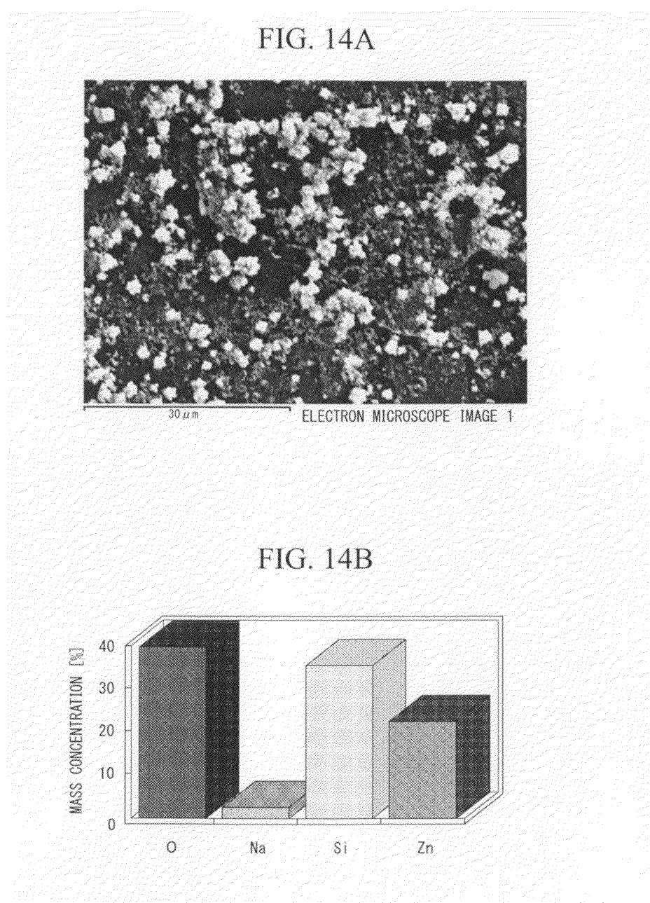

FIG. 14A is a SEM image of the fabricated thin film, and FIG. 14B is a result of the composition analysis by EDX.

As shown in FIG. 14A, grains of 1 μm or less are grown and form the thin film. In addition, as shown in FIG. 14B, the thin film includes more zinc atoms contained in zinc oxide which is the target product than Na atoms which originate from the sodium hydroxide aqueous solution which is the basic solution. First, because film formation is performed by using a coating solution which is not diluted, it is considered that a thin film having the same composition as that of Comparative Example 2 described above is formed before immersion into warm water. However, as shown in FIG. 14B, because the content of sodium atoms is less than the content of zinc atoms, it is considered that sodium compounds in the thin film are removed by the rinsing in warm water.

Note that, part of silicon atoms and oxygen atoms detected in FIG. 14B is a value measured for the glass which is the substrate.

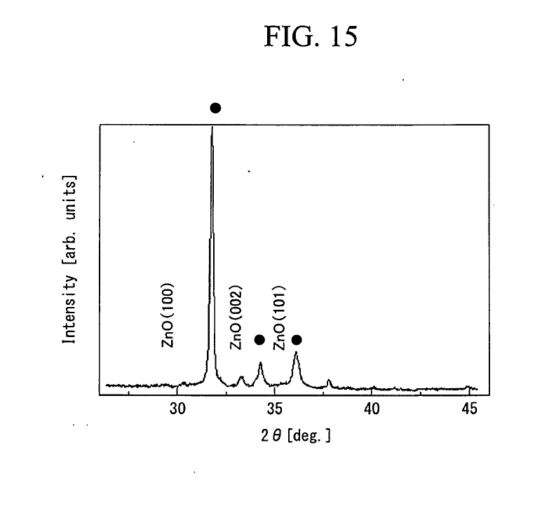

FIG. 15 shows an X-ray diffraction result of the thin film measured by the θ-2θ method using an X-ray diffraction apparatus. As a result of the measurement, a (100) plane, a (002) plane, and a (101) plane of zinc oxide are confirmed, and it was found that the grains which constitute the thin film are zinc oxide crystals.

From the results described above, the usefulness of the present invention was confirmed.

In an embodiment of the present invention, a method of manufacturing a zinc oxide thin film includes: preparing a basic solution containing tetrahydroxozincate (II) ions and having a pH of 10 or more; diluting the basic solution such that the pH becomes 8.5 or less; applying the basic solution to a substrate; and heating the basic solution.

In an example of the embodiment described above, the manufacturing method can include applying the basic solution to the surface of the substrate while diluting the basic solution .on the substrate.

In addition, in an example of the embodiment described above, the manufacturing method can include diluting the basic solution with pure water.

In addition, in an example of the embodiment described above, the manufacturing method can include rinsing a zinc oxide thin film formed on the substrate.

In addition, in an example of the embodiment described above, the manufacturing method can include applying the basic solution to the preliminarily heated substrate and heating the basic solution on the substrate.

In addition, in an example of the embodiment described above, the manufacturing method can include applying the basic solution which is preliminarily heated onto the substrate.

In another embodiment of the present invention, a method of manufacturing a zinc oxide thin film includes: applying a basic solution which contains tetrahydroxozincate (II) ions to a substrate; and heating the basic solution, and further includes at least any one of diluting the basic solution such that the pH becomes 8.5 or less and rinsing a compound which is deposited on the surface of the substrate.

In an example of the embodiment described above, the manufacturing method can include both diluting the basic solution such that the pH becomes 8.5 or less and rinsing a compound which is deposited on the surface of the substrate.

What is claimed is:

1. A method of manufacturing a zinc oxide thin film, the method comprising:
preparing a basic solution containing tetrahydroxozincate (II) ions and having a pH of 10 or more;
diluting the basic solution such that the pH becomes 8.5 or less;
applying the basic solution to a substrate; and
heating the basic solution.

2. The method of manufacturing a zinc oxide thin film according to claim 1, wherein the basic solution is applied to a surface of the substrate while the basic solution is diluted on the substrate.

3. The method of manufacturing a zinc oxide thin film according to claim 1, wherein a zinc oxide thin film formed on the substrate is rinsed.

4. The method of manufacturing a zinc oxide thin film according to claim 1, wherein the basic solution is diluted with pure water.

5. The method of manufacturing a zinc oxide thin film according to claim 1, wherein the basic solution is applied to the preliminarily heated substrate, and the basic solution is heated on the substrate.

6. The method of manufacturing a zinc oxide thin film according to claim 1, wherein the basic solution which is preliminarily heated is applied onto the substrate.

7. A device comprising a zinc oxide thin film manufactured by using the method according to claim 1.
